(19) United States
(12) Patent Application Publication
(10) Pub. No.: US 2020/0162463 A1
(43) Pub. Date: May 21, 2020

(54) SYSTEM AND METHOD FOR MANAGING AN AUTONOMOUS LICENSING ENTITY

(71) Applicants: Jebb A. Dykstra, Santa Monica, CA (US); Michael A. Kerr, Reno, NV (US)

(72) Inventors: Jebb A. Dykstra, Santa Monica, CA (US); Michael A. Kerr, Reno, NV (US)

(21) Appl. No.: 16/459,268

(22) Filed: Jul. 1, 2019

Related U.S. Application Data
(63) Continuation of application No. 15/851,649, filed on Dec. 21, 2017, now abandoned.
Application No. 15/851,649 is a continuation of application No. 13/802,155, filed on Mar. 13, 2013, now abandoned.
(60) Provisional application No. 62/693,426, filed on Jul. 2, 2018.

(51) Int. Cl. H04L 29/06

(52) U.S. Cl. CPC H04L 63/10; H04L 63/104

(57) ABSTRACT

A system and method for managing a vehicle cloud service are disclosed. The system utilizes a cloud management module resident on a server that transmits vehicle access invitations to end users according to a per-seat license that is capped with an upper limit of end users. A synchronization module synchronizes directory services for one or more cloud services including the vehicle cloud service and synchronizes the directory services with a licensing operational database. End users are offered cloud service upgrades and/or add-ons for access to a user profile associated with the end user.

### CROSS REFERENCES

This patent application claims the benefit of provisional patent application 62/693,426 filed Jul. 2, 2018 entitled SYSTEM AND METHOD FOR MANAGING AN AUTONOMOUS LICENSING ENTITY;

this patent application is a continuation of patent application 15/851,649 filed Dec. 21, 2017 entitled CONTROLLING ACCESS TO ENTERPRISE SOFTWARE;

this patent application is a continuation of patent application Ser. No. 13/802,155 filed Mar. 13, 2013 entitled CONTROLLING ACCESS TO ENTERPRISE SOFTWARE (now abandoned); and

the above patent applications are hereby incorporated by reference in this patent application.

### FIELD

The description relates to a system and method for managing an autonomous licensing entity. More specifically, the description relates to a system and method for controlling seat licensing levels of a fleet of electronically accessible vehicles to autonomous entities through data brokering. The autonomous entity covers all types of self-governing end users including people, artificial intelligence (AI), and hybrids in a shared infrastructure of metered or non-metered usage of multiple cloud services.

### BACKGROUND

Traditional infrastructure involves an endpoint, which is a computing device with an interactive screen known as a mediator with a graphical user interface (GUI). An autonomous entity embodied as a natural intelligence (human user) interacts with the endpoint through physical gestures (e.g., typing, swiping, scrolling). However, embodiments of autonomous entities further comprise self-governing end users such as people, artificial intelligence (AI), and hybrids. Thus, an autonomous entity might not need to be required to type, swipe or scroll in order to interact with another autonomous entity. Furthermore, conventional forms of payment might not be required from autonomous entities in a shared infrastructure with per-seat licensing.

The migration to cloud computing for enterprise solutions has created some unique challenges that relate to managing “per-seat licenses” for autonomous entities. For example, there are various limitations associated with the System Administrator controlling or managing the per seat licensing in a cloud-based enterprise software implementation. The limitations include determining which endpoints are going to access the licensed service, at which times those endpoints access the licensed service, and minimizing the need for a System Administrator. Further, controlling seat licensing levels for a service provided through a predetermined number of physical interfaces, such as for example, a fleet of vehicles, a set of smartphones, or a set of tablets requires additional management to prevent an otherwise non-metered service from double-booking a single physical interface.

### SUMMARY

A system for managing a vehicle cloud service is described. The system includes a per-seat license, a directory service, a client device, a cloud management module, a vehicle access invitation, and a synchronization module. The per-seat license is associated with the vehicle cloud service that includes an upper limit of end users that can access the vehicle cloud service and an end date for the per-seat license. The vehicle cloud service, the directory service, and the client device are communicatively coupled to a network. The vehicle cloud service is further communicatively coupled to an electronically accessible vehicle. The directory service manages the per-seat license associated with the vehicle cloud service. The client device includes a user profile. The cloud management module is communicatively coupled to the directory service and the vehicle cloud service. The cloud management module originates a query requests the user profile associated with the client device and the vehicle access invitation. The vehicle access invitation authorizes the per-seat license associated with the vehicle cloud service. The vehicle access invitation is transmitted to the client device when the user profile associated with the client device is received by the cloud management module. The client device generates a responsive message that includes the user profile. The synchronization module synchronizes the directory service according to the vehicle access invitation so that the upper limit of the per-seat license is not exceeded.

In another embodiment, a method for managing a vehicle cloud service is described. The method includes a cloud management module queries a client device to request identification of the client device. The request is transmitted via a network coupled to the cloud management module and the client device. The cloud management module queries the client device to request a user profile associated with the client device. The client device transmits a responsive message that includes the user profile associated with the client device. The cloud management module receives the responsive message from the client device and transmits a vehicle access invitation when the user profile associated with the client device is received by the cloud management module. The vehicle access invitation authorizes a per-seat license associated with the vehicle cloud service. The per-seat license includes an upper limit. And a synchronization module synchronizes a directory service according to the vehicle access invitation. The directory service is communicatively coupled to the network and manages the per-seat license associated with the vehicle cloud service so that the upper limit of the per-seat license is not exceeded.

### FIGURES

The present invention will be more fully understood by reference to the following drawings which are presented for illustrative, not limiting, purposes.

FIG. 1 shows a system for managing a plurality of autonomous licensing entities in a multi-cloud architecture.

FIG. 2 shows an illustrative client device.

FIG. 3 shows relationships between a plurality of autonomous entities including machine-to-machine interactions.

FIG. 4 shows an embodiment of human-cloud-human and human-cloud-machine interaction using a system and method for managing an autonomous licensing entity with a per-seat license in a multi-cloud architecture.

FIG. 5 shows a flowchart describing a method for managing an autonomous licensing entity with a per-seat license level using a digital invitation in a multi-cloud architecture.

FIG. 6 shows an embodiment of the system and method for a first cloud service linked to a fleet of autonomous vehicles and a second cloud service linked to at least one electronically accessible vehicle.

FIG. 7 shows a cloud management console having a hierarchical network Administrator framework for controlling per seat licenses for cloud services.

FIG. 8 shows a flowchart of an embodiment of the system and method for a plurality of autonomous entities using a physical layer, a network layer, and a multi-cloud layer.

FIG. 9 shows a flowchart of a layer model using a multi-cloud architecture.

FIG. 10 shows an automated passive payment architecture for autonomous entities.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. The following detailed description of the illustrative embodiments includes reference to the accompanying drawings, which form a part of this application. The drawings show, by way of illustration, specific embodiments in which the invention may be practiced. It is to be understood that other embodiments may be utilized, and structural changes may be made without departing from the scope of the claims.

The systems and method described herein manage an autonomous licensing entity. A per-seat license for cloud-based services is a software or hardware license based on the number of autonomous entities who have access to enterprise software, hardware or cloud service(s). The per-seat license to the cloud service includes the upper limit of autonomous entities that can access the cloud service and an end date for the per-seat license. An autonomous entity profile includes data fields configured to be communicated to at least a first cloud service and a second cloud service. Especially when the autonomous entity is a natural intelligence, the profile data may have intrinsic value for marketing products and services to that natural intelligence or person unrelated to the cloud service corresponding to the per-seat license. Although, profile data corresponding to any autonomous entity may yield valuable information when examined in a bulk format. Thus, profile data corresponding to all autonomous entities, including both natural and artificial intelligences may be brokered for in exchange for one or more per-seat licenses for a cloud service.

A multi-cloud architecture is comprised of a system and method for distributing workloads among different cloud providers including but not limited to Amazon cloud, Google cloud, Microsoft Azure cloud, IBM Cloud, Salesforce Sales Cloud, Oracle Cloud, Alibaba Cloud, VMware Cloud, et al. A hybrid-cloud architecture is comprised of a private network and a single cloud provider. A hybrid-multi-cloud architecture is comprised of a private network utilizing multiple cloud service providers. Specifically, Google Maps platform, geolocation APIs, Google Places API. Azure Media Services, Hot and Cold Blob and queue storage services. Azure App Services to deliver web and mobile data via proprietary Web API. Microsoft web API authentication via OAuth2, Identity Server 4, and 2-factor authentication. Azure Cognitive services to provide vision, image-processing and recognition, Amazon Web Services (AWS) to deliver compute and storage services.

The systems and methods presented herein provide a deterministic approach to resource allocation through per-seat licenses that could mitigate the issues of associated costs, system overloads, and denial of services. Additionally, the systems and methods provide a hierarchy of per-seat licenses for autonomous entities that could enable the ability to provide more granular access to a plurality of cloud features, which may operate through particular hardware.

The system and method presented herein manages cloud computing features for licensing, billing, and data/information for sharing with autonomous entities. The system and method provides time-sensitive access to services that require different workloads. Additionally, the system and method presented herein may be used by cloud service providers in a multi-cloud architecture. The systems and methods presented herein also manage and control licensing and billing.

The systems and methods presented herein may also be used with a self-governing machine such as an autonomous vehicle, which recharges with a smart charging station. A fleet of autonomous vehicles would not require direct human supervision while recharging or refueling, and efficiency would be improved without direct human supervision. Effectively, such a system would be safer as it can be monitored remotely as opposed to traditional methods of direct contact with the source of energy or fuel and without the need for on-site payment. The system and method presented herein can also manage an autonomous licensing entity that charges costs associated with machine-to-machine interactions using a hierarchy of per-seat licenses for non-metered usage of one or more cloud services. A fleet of autonomous vehicles would reduce car ownership while maximizing utilization of shared transportation. Effectively, reducing the problem associated with car ownership including but not limited parking, permits, maintenance, depreciation, etc. Ideally, a system and method for managing per-seat licensing of a fleet of autonomous vehicles maximize the efficiency of a shared pool of resources among autonomous entities. Cloud-based services in particular may be used for management of a fleet of autonomous entities and add-on services for those autonomous entities.

In one exemplary embodiment, per-seat licenses for a fleet of electronically accessible rental vehicles are managed by the system and method disclosed herein, so that the per-licenses are transferred among the particular electronically accessible rental vehicles to accommodate intermittent patronage and vehicle turnover.

An autonomous entity includes people (natural intelligence), robots, drones, smart appliances, autonomous vehicles, autonomous virtual desktops, artificial intelligence computing or hybrids.

The present systems and methods expand the uses, throughput, distribution, architecture, and applications of managing a per-seat license for a plurality of autonomous entities.

An endpoint may be comprised of a virtual desktop, robots, drones, vehicles, windmills, appliances, software applications, hardware devices, embedded systems, sensors, and IP enabled devices.

A fleet of autonomous entities is comprised of a plurality of autonomous entities communicatively coupled to artificial intelligence or machine intelligence for machine-to-machine self-governing operations.

An autonomous entity may be capable of signing, requesting, and using a cloud service through an integrated endpoint. Additionally, endpoint(s) may be broadly defined as delivery mechanisms of a cloud service to the autonomous entity when using a valid per-seat license. Furthermore, each per-seat license level is correlated to a hierarchy of features corresponding to the cloud service to which the per-seat license grants use rights or access.

The systems and methods enable machine-cloud-machine interactions, human-cloud-human interactions, and human-cloud-machine interactions using per-seat licensing for cloud services subdivided into a plurality of features. In one embodiment, the autonomous system and method are capable of using, distributing, or managing a per-seat license to proprietary software for self-governed interactions between artificial intelligence and an autonomous vehicle for updates, energy management, payments, analytics, entertainment, access control, and predictive maintenance.

For the purposes of this disclosure, Mobility-as-a-Service (MaaS) is the usage of a service that is provided by a cloud service provider through a plurality of secure cloud enclaves equipped with a plurality of distinct features.

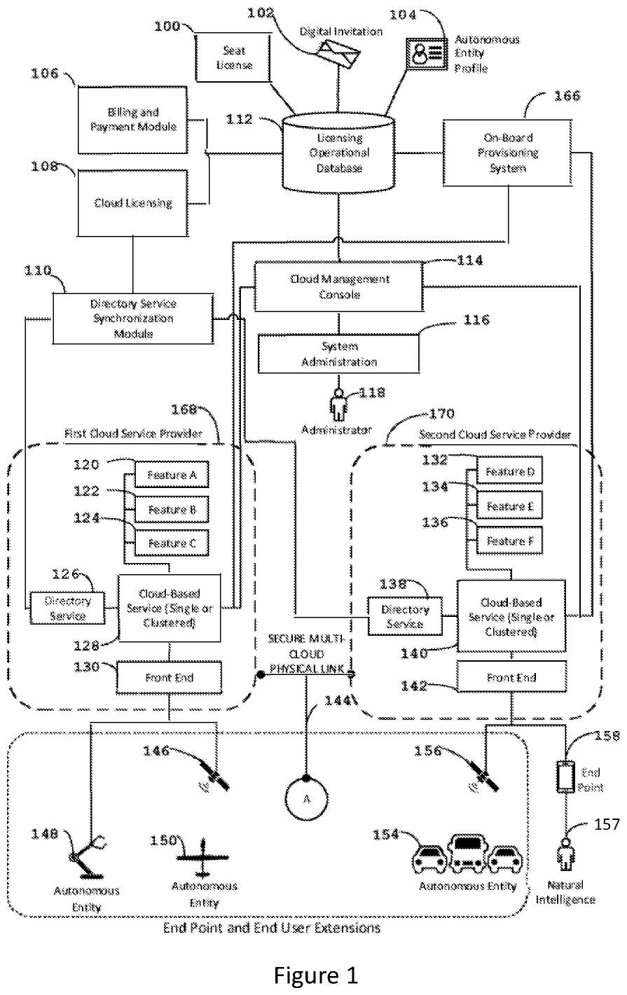

An illustrative system drawing is presented in FIG. 1, which supports autonomous entities and endpoint extensions. The architecture diagram of FIG. 1 describes a system comprising elements such as a per-seat license 100, a digital invitation 160, and an autonomous entity profile 104 stored in a Licensing operational database 112 or equivalent storage. The system includes a cloud billing module 164, a cloud licensing module 166, and an on-board provisioning system 166 communicatively coupled to the Licensing operational database 112. A Directory Service Synchronization Module 110 is in charge of synchronizing directory services among a plurality of cloud services 168 and 170. A Cloud Management Console 114 is communicatively coupled to a System Administration system 116 used by administrators 118 of the multiple cloud services 168, 170. Each of the cloud services 168, 170 include a plurality of features 120, 122, 124, 132, 134, 136, a directory service 126, 138, a Front End 130,142, and a Cloud-Based Service (Single or Clustered) 128,140. A secure multi-cloud physical link is shown 144 between the cloud services 168 and 170.

The secure multi-cloud physical link 144 comprises a physical connection between cloud service providers that is secure, low latency, high availability, high throughput, and high reliability.

Endpoints and autonomous entities are illustrated with a line indicating a relationship that can take many shapes and forms, which can include a communicative coupling (i.e., being in wireless or wired communication), a physical link (i.e., physical contact), control or ownership thereof (i.e. a person owning or operating a smartphone or tablet), or other such relationship.

The on-board provisioning system 166 includes a self-provisioning system, access control of the multi-cloud architecture, an on-boarding engine, and a management module used to control a plurality of cloud services. The self-provisioning system allows autonomous entities to register and launch a plurality of cloud features without direct interventions from a Multi-Cloud Administrator (MCA). Access control of the multi-cloud architecture is achieved through authentication of device information unique to each autonomous entity, i.e. unique device ID. The on-boarding engine enters or enrolls autonomous entities in a database of autonomous entities entitled to use or access one or more of the cloud services 168 and 170 associated with the per-seat licenses 100 distributed and managed by the system.

In one embodiment, the system and method refer to bringing premises-based enterprise services to a public cloud or private cloud deployment. The cloud licensing module 166 may be configured to identify a maximum number of autonomous entities that can access each cloud service and an end date for accessing each cloud feature. The maximum number of autonomous entities that can access each cloud service is an upper limit of per-seat licenses that may be active during the same period of time. The cloud licensing module determines the upper limit for a particular cloud service and determines whether the number of active licenses is greater than, equal to, or less than the upper limit. When the number of active licenses is greater than or equal to the upper limit, the cloud licensing module denies any request for a per-license, or does not issue a digital invitation for the particular cloud service. Additionally, when the number of active licenses is greater than the upper limit for the cloud service, the cloud licensing module can revoke one or more active licenses to reduce the number of active licenses to a number equal to the upper limit. When the number of active licenses is less than the upper limit, the cloud licensing module approves license requests or issues digital invitations. In some embodiments, the cloud licensing module may store a global autonomous entity profile 104 associated with a predetermined set of profile features, such as financial commitments, budgets, and pre-approvals for autonomous entities to accept licenses.

The Directory Service Synchronization module 110 enables the Licensing Operational Database 112 to synchronize with each of the directory services 126 and 138 according to each autonomous entity's accepted digital invitations 160. Thus, in one embodiment, digital invitations 160 including license activation information or otherwise providing authentication for the receiving autonomous entity to utilize a per-seat license for a particular cloud service that have been issued by the Licensing Operational Database 112 to an autonomous entity are tracked by the Licensing Operational Database 112 upon issuance, but are not tracked by the Directory Service Synchronization module 110 until the autonomous entity redeems the digital invitation 160 or attempts to access the associated cloud service. When the autonomous entity does redeem or attempt to access the associated cloud service, the directory service for the cloud service authenticates the information in the digital invitation and logs identifying information for the autonomous entity. This logged information is communicated from the directory service to the Directory Service Synchronization module 110, which synchronizes the records of the Licensing Operational Database 112 to reflect that the issued digital invitation has been utilized by the autonomous entity. Further, the date, time, and duration (where appropriate) of the cloud service access by the autonomous entity is recorded.

The illustrative cloud services may be embodied as one of four fundamental cloud service models, namely, infrastructure as a service (IaaS), platform as a service (PaaS), software as a service (SaaS), and network as a service (NaaS).

A broadband channel supporting wireless communications illustrated as 146, 156 may comprise 4G and 5G support or other available wireless networks. An autonomous entity can communicate using a broadband network with low latency, high availability, high reliability, and high mobility.

An autonomous entity is comprised of people (natural intelligence) 157, robots 148, drones 150, and autonomous vehicles 154. An endpoint 158 may be comprised of a smartphone, a tablet, a laptop, a desktop computer, a Wi-Fi enabled vehicle, or other computing device for individual use. In addition, an endpoint may be integrated into an autonomous entity, such as robots 148, drones 150, and autonomous vehicles 154.

In another embodiment, the system and method are hosted in a plurality of cloud service providers such as Amazon cloud, Microsoft Azure cloud, Google cloud, IBM Cloud, Salesforce Sales Cloud, Oracle Cloud, Alibaba Cloud, or VMware Cloud, et al.

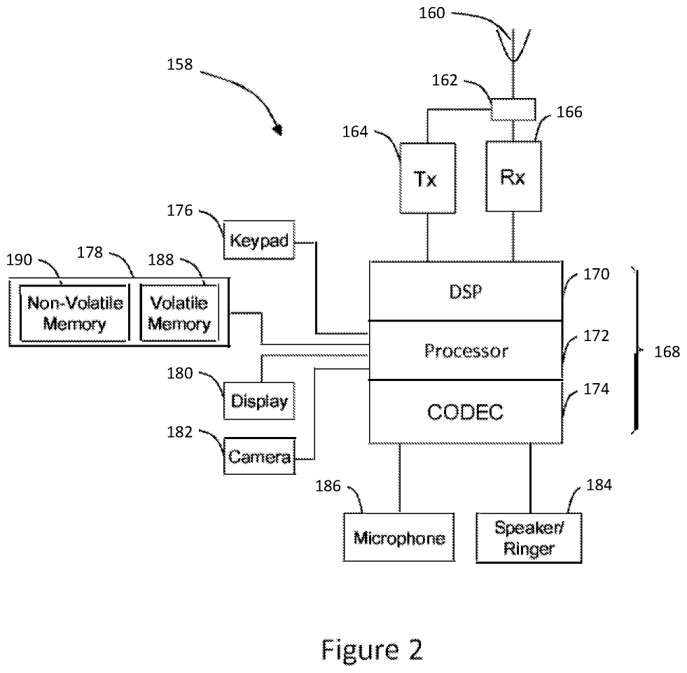

Referring to FIG. 2 there is shown the electrical components for an illustrative wireless endpoint 158, also termed a client device. The illustrative endpoint 158 is a multimode wireless device that comprises a first antenna element 160 that is operatively coupled to a duplexer 162, which is operatively coupled to a multimode transmitter module 164, and a multimode receiver module 166.

An illustrative control module 168 comprises a digital signal processor (DSP) 170, a processor 172, and a CODEC 174 that are communicatively coupled to the transmitter 164 and receiver 166. It shall be appreciated by those of ordinary skill in the art that the transmitter module and receiver module are typically paired and may be embodied as a transceiver. The illustrative transmitter 164, receiver 166, or transceiver is communicatively coupled to antenna element 160.

The DSP 170 may be configured to perform a variety of operations such as controlling the antenna 160, the multimode transmitter module 164, and the multimode receiver module 166. The processor 172 is operatively coupled to a keypad 176, a memory 178, a display 180, and camera 182. Additionally, the processor 172 is also operatively coupled to the CODEC module 174 that performs the encoding and decoding operations and is communicative coupled to a speaker or ringer 184, and a microphone 186. The CODEC module 174 is also communicatively coupled to the display 180 and provides the encoding and decoding operations for video.

The memory 178 includes two different types of memory, namely, volatile memory 188 and non-volatile memory 190. The volatile memory 188 is computer memory that requires power to maintain the stored information such as random access memory (RAM). By way of example and not of limitation, images presented in preview mode would use the storage resources corresponding to the volatile memory 188. The non-volatile memory 190 can retain stored information even when the endpoint (e.g., wireless communication device) 158 is not powered up. Some illustrative examples of non-volatile memory 190 include flash memory, ROM memory, and hard drive memory. In the illustrative embodiment, the captured image is processed using a volatile memory 188 and stored in the non-volatile memory 190.

In various embodiments, endpoint 158 may be a mobile handset, mobile phone, wireless phone, portable cell phone, cellular phone, portable phone, a personal digital assistant (PDA), a tablet, a portable media device, or any type of mobile terminal which is regularly carried by an end user and has all the elements necessary for operation in a wireless communication system, additionally the endpoint 158 may be a stationary home computer, a stationary computing device, or an electronically accessible vehicle that is Wi-Fi enabled. The wireless communications include, by way of example and not of limitation, CDMA, WCDMA, GSM or UMTS or any other wireless communication system such as wireless local area network (WLAN), Wi-Fi or WiMAX. The endpoint 158 comprises a device content interface. The device content interface is a graphical user interface that displays content on a display of the endpoint 158. The device content interface may also be configured to receive end user input, such as feedback pertaining to the displayed content and user-created content. The device content interface may be an application running on a processor of the endpoint 158. In other embodiments, the device content interface is accessed via network, for example, using an internet browser application or a cloud service specific application running on a processor of the endpoint 158.

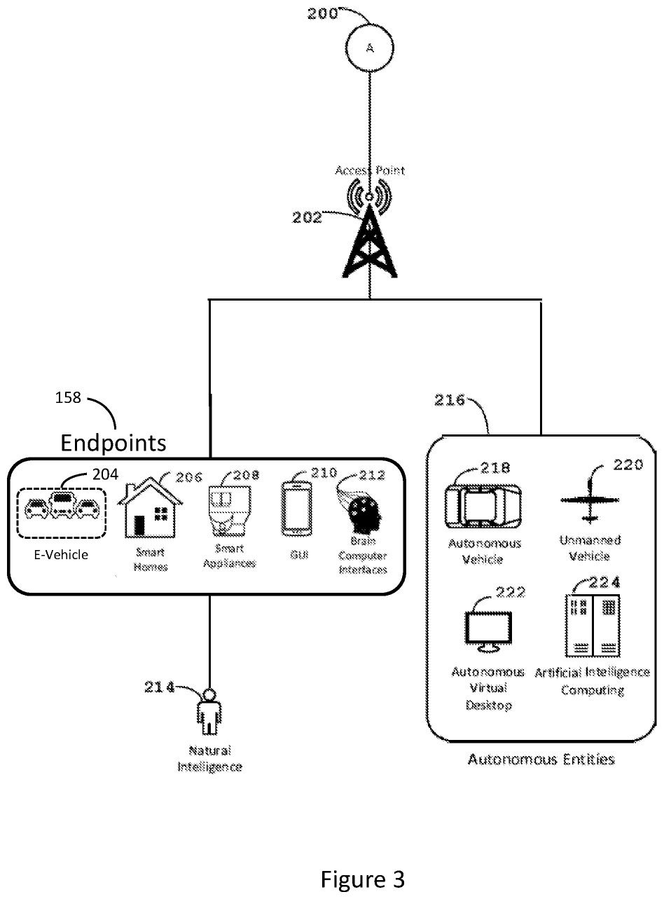

Referring now to FIG. 3, there is shown an embodiment 200 including a fixed Access Point 202 communicatively coupled to endpoints 158 and autonomous entities 216. The Endpoints 158 may include electronically accessible vehicles (E-Vehicles) 204, smart homes 206, smart appliances 208, graphical user interface (GUI) 210, and brain-computer interfaces 212, with which a natural intelligence (person) 214 interacts by receiving output from an endpoint 158 and providing input to the endpoint 158.

A group of autonomous entities 216 may include at least one autonomous entity capable of self-governing and self-administration. The group of autonomous entities 216 may also include a plurality of autonomous vehicles 218, an unmanned drone 220, an autonomous virtual desktop 222, and artificial intelligence (AI) computing 224. In addition, the group of autonomous entities 216 can be embodied as, and referred to as, a fleet of autonomous vehicles.

In an exemplary embodiment, a rental company may operate the fleet of autonomous vehicles and distribute through the access point 202 a number of per-seat licenses to certain of the autonomous vehicles in the fleet that request or need a per-seat license for a certain cloud service.

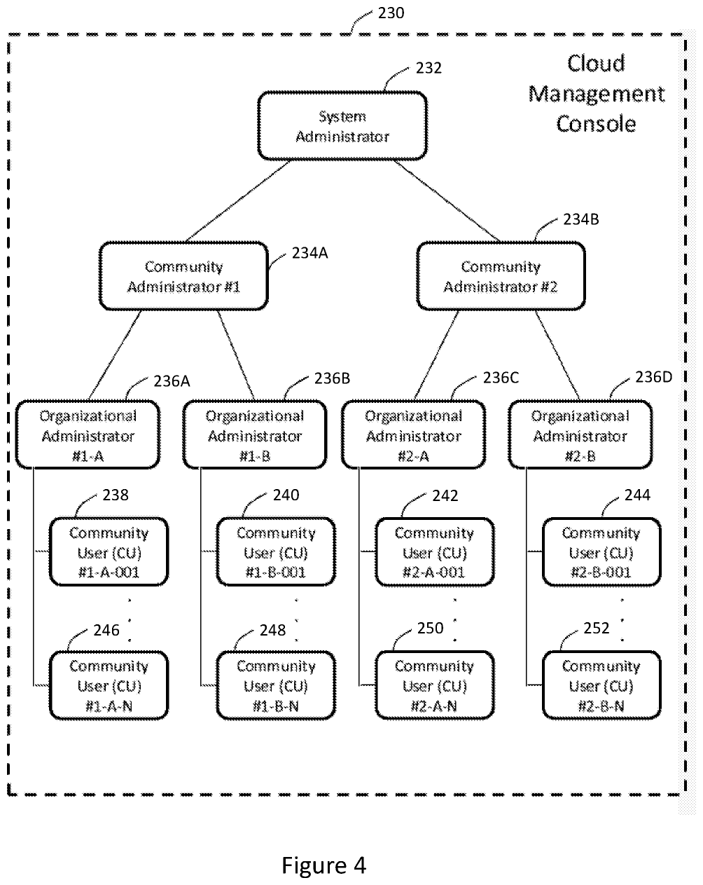

Referring to FIG. 4 there is shown a cloud management console 230 having a hierarchical network Administrator framework for controlling per seat licenses for cloud services. The hierarchical network Administrator framework can also be used to control access to a cloud service on a premise-based server.

The illustrative cloud management console 230 has a hierarchical network Administrator framework that includes a first-tier Administrator that is referred to as a System Administrator (SA) 232, a second-tier Administrator referred to as a Community Administrator (CA) 234A-B, a third-tier Administrator referred to as an Organization Administrator (OA) 236A-D, and a plurality of end users (i.e., endpoint or autonomous entity), in this illustrative example referred to as Community Users (CUs) 238-252.

Generally, the first-tier Administrator 232 identifies a community and an upper limit of end users that can belong to the community. The second-tier Administrator 234 is selected by the first-tier Administrator 232 and creates at least one Organizational Unit that is a subset of the end users within the community. The third-tier Administrator 236 is selected by the second-tier Administrator 234 and can add end users to the Organizational Unit. Each end user is presented with a user interface (UI) that includes all the Organizational Units. By way of example and not of limitation, each Organizational Unit corresponds to a particular cloud service.

In some embodiments, the cloud management console 230 can be part of the on-board provisioning system 150. In other embodiments, the cloud management console 230 may be embodied as a standalone module that includes the directory service synchronization module, as a relational database having the appropriate schema, as an independent cloud licensing module, or as a combination thereof.

In general, the operations performed by the cloud management console 230 are related to supporting a hierarchical network Administrator framework that controls access to one or more cloud services in a manner consistent with the per-seat licensing requirements for each cloud service.

More particularly, the cloud management console 230 enables a System Administrator (SA) 232 to create new communities, edit communities, and delete communities. The SA 232 has a relatively broad set of rights and privileges. In the illustrative embodiment, the SA 232 can assign a more limited set of rights (than the SA rights) to the Community Administrator (CA) 234A and 234B. The SA 232 can also create at least one Organizational Unit that is a subset of end users within the community.

In the illustrative embodiment, the hierarchical network Administrator framework is operatively coupled to the Licensing Operational Database 112 (shown in FIG. 1) that the first-tier Administrator (System Administrator) 232 can control by identifying the community and the upper limit of end users that can belong to the community. Simply put, the first-tier Administrator (SA) 232 provides the second-tier Administrator (CA) 234 and third tier Administrator (OA) 236 with limited access to the database 112.

The illustrative embodiment also includes a digital invitation communicated from one of the Administrators to an end user, in which the digital invitation enables the end user to access the cloud service when the end user accepts the invitation. Depending on the assigned privileges or rights, either the SA 232 or CA 234 can remove end users from the community when the end user does not accept an invitation communicated from one of the Administrators. Additionally, at least one group that is a subset of the Organizational Unit and either the SA 232 or CA 234 is capable of adding end users to the group depending on the assigned privileges or rights.

The system may also include a per seat license to the cloud service, wherein the license includes the upper limit of end users that can access the cloud service. In the illustrative embodiment, licensing is managed by a cloud licensing module 108 (see FIG. 1), which also includes an end date for the per-seat license.

The hierarchical network Administrator framework system may also support a group that is a subset of the Organizational Unit so that the third-tier Administrator 236 may add or remove end users from the group. The third-tier Administrator (OA) 236 may also remove users from the community when the end users do not accept an invitation communicated from the Administrator to the end user, in which the invitation enables the end user to access the cloud service. In the illustrative embodiment, the second-tier Administrator 234 can also add or remove end users from the Organizational Unit.

In the illustrative embodiment, the SA 232 has assigned Community Administrator #1 234A and Community Administrator #2 234B with the rights to administrate an Organizational Unit (OU). Additionally, the Community Administrator (CA) 234 can impose maximum end user limits and service expiration dates for the Organizational Unit. The CA 234 can also create Groups within an organization, e.g. a “sales” group and a “support” group. The Community Administrator 234 may also assign end users to the Organizational Unit and Group. The Community Administrator 234 can also add new end users to the community.

The Community Administrator 234 may also assign an even more limited set of rights (than the CA rights) to an Organizational Administrator (OA) 236. The Organization Administrator (OA) 236 is assigned to administrate their organization. The Organizational Administrator 236 may also add end users to the Organizational Unit or remove end users from the Organization Unit. The Organization Administrator 236 can also add, delete and remove end users from a Member Distribution Group. Additionally, the OA 236 can also reset passwords and create new passwords. Thus, the CA 234 may assign the right to administrate an Organizational Unit to the Organizational Administrator.

In an illustrative example, the Community Administrator 234A assigns rights to Organizational Administrator 236A and 236B, and CA 234B assigns rights to OA 236C and OA 236D. Each Organizational Administrator 236 has management and control over their respective Organization Unit, which includes at least one Community User (CU) 238-252. For example, OA 236A has management and control over community users 238 and 246; OA 236B has management and control over CU 240 and 248; OA 236C has management and control over CU 242 and 250; and OA 236D has management and control over 244 and 252.

The Community User (CU) is the end user that may have access to the cloud service. In one embodiment, the Community User is presented with a User Interface (UI) that includes the Communities that are available to the particular user. By way of example, the UI may be a cloud management console that is also available to System Administrators, but without the CU having Administrator privileges. Additionally, the CU can view the Community setting and configuration information. Once the CU has accepted the invitation, the CU can download software that is available to the user's community.

Generally, the Community User can view, add, edit, and delete personal meeting rooms. Additionally, the Community User can view, add, and edit personal profile information and change his/her password. Thus, when a user authenticates to the Cloud Management Console (CMC), the user is able to see all of the managed Communities that they belong to. Additionally, the user can see the configuration parameters to configure their Unified Communications Client to authenticate to each server. Furthermore, the user can see all configuration information necessary to utilize the features of that community, such as Broadsoft Plugin installation and settings, Polycom video conferencing plug ins and settings, Desktop SIP phones and more.

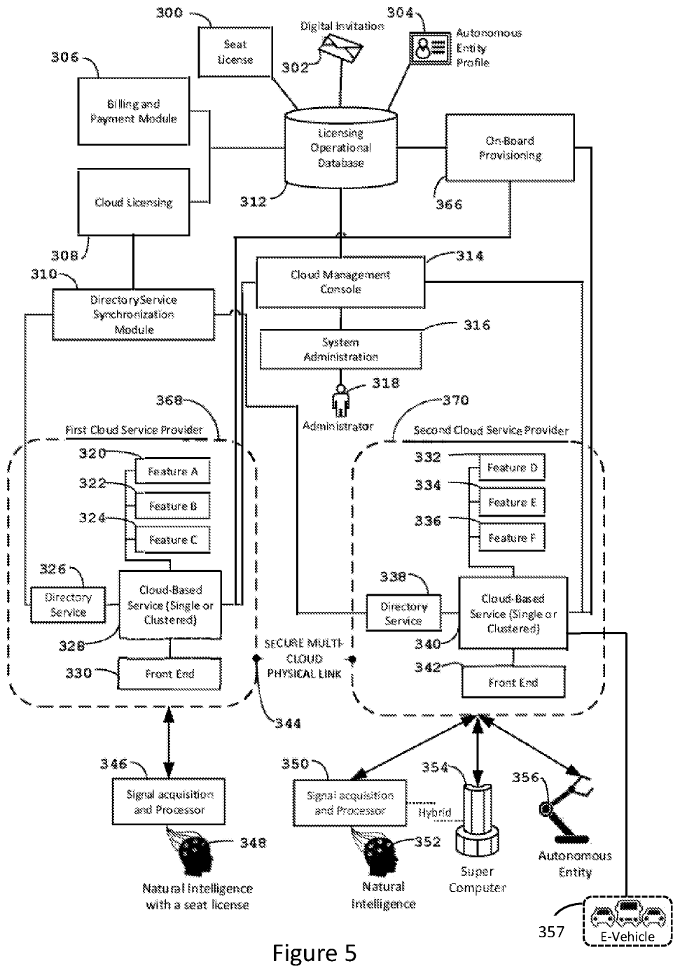

Referring to FIG. 5, there is shown a further embodiment where an autonomous entity with a per-seat license 300 requests usage of another autonomous entity bonded to the per-seat license. The system and method for managing autonomous licensing entities include machine-to-machine (M2M) or natural-to-natural (N2N) interactions and combinations.

The architectural diagram of FIG. 5 describes a system comprising the elements of a per-seat license 300, a digital invitation 302, and an autonomous entity profile 304 stored in a Licensing Operational Database 312 or equivalent storage. The system includes a cloud billing module 306, a cloud licensing module 308, and an on-board provisioning system 366 communicatively coupled to the Licensing Operational Database 312. A Directory Service Synchronization Module 310 is in charge of synchronizing directory services among a plurality of cloud services 368 and 370. A Cloud Management Console 314 is communicatively coupled to a System Administration 316 used by administrators 318 of the multi-cloud 368, 370. Cloud services 368 and 370 include a plurality of features 320, 322, 324, 332, 334, 336, a directory service 326, 338, a Front End 330, 342, and a Cloud-Based Service (Single or Clustered) 328, 340. Additionally, a secure multi-cloud physical link is shown 344.

Furthermore, signal acquisition and processor modules 346, 350 are communicatively coupled to natural intelligence with a per-seat license 348 and natural intelligence without a per-seat license 350 for surrogate operations or natural-to-natural (N2N) interactions. The natural intelligence 352 may be assisted by a supercomputer 354 in a hybrid mode. In addition, the natural intelligence with a per-seat license 348 is able to interact with a plurality of autonomous entities, such as the illustrative robotic arm 356, and with other endpoints, such as the illustrative e-vehicles 357. In the illustrative embodiment, the natural intelligence 352 receives authorization corresponding to a per-seat license to engage in non-metered or metered usage/control of the autonomous robotic arm 356 or one or more of the e-vehicles 357.

The computational requirements to process invasive or noninvasive brain controller interfaces (BCI) feeding streams of data would require additional storage, processing, and bandwidth than a simple request using an application programming interface (API).

Computer-brain interfaces can be invasive or noninvasive. A plurality of computer brain technologies for signal acquisition include but are not limited to Electroencephalogram (EEG), Electrocorticography (ECoG), extracellular Action Potentials (APs), Local Field Potentials (LFP), et al. The processor may include signal processing functions using autoregression, wavelets, Fourier transforms, Laplacian filters, and other spatial filters.

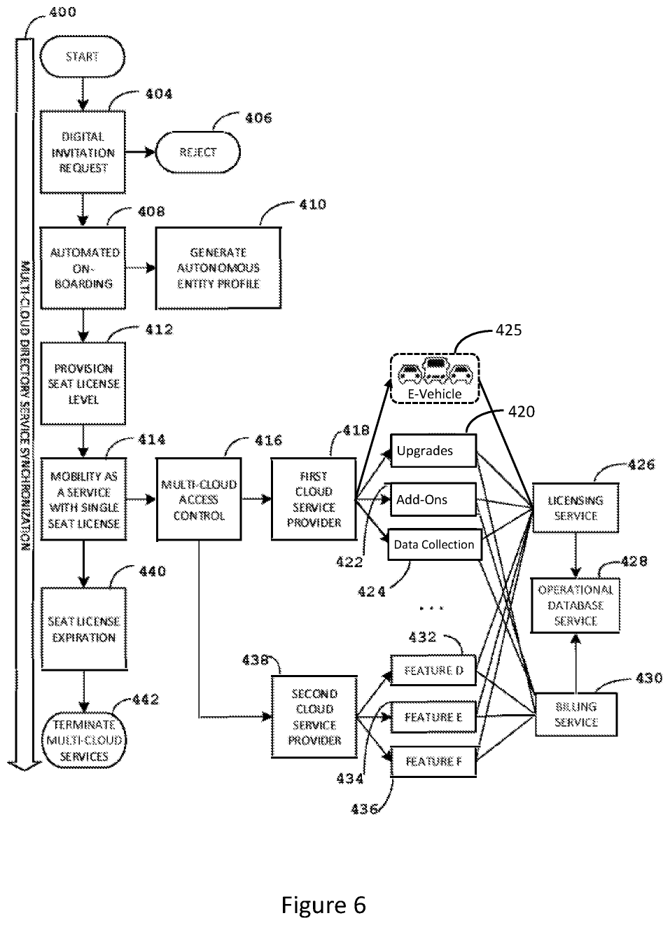

Regarding the flowchart illustrated in FIG. 6, an autonomous entity acquires a digital invitation from an on-board provisioning system using an internal endpoint 404. The autonomous entity may REJECT 406 a previously offered or requested invitation if an intelligent module determines that the state desired from a particular digital invitation has been reached through other means including local computations. Therefore, a REJECT would release a per-seat license assigned to a digital invitation and a directory service synchronization registers the REJECT by updating the Licensing Operational Database to reflect the autonomous entity REJECT. In turn, the Directory Service Synchronization module updates the directory service corresponding to the rejected digital invitation by removing the unique authorization associated with the digital invitation. The on-boarding process 408 comprises registering an autonomous entity unique identifier automatically by the autonomous entity using an internal endpoint 410.

In one embodiment, the cloud management module first queries an endpoint for identifying information that can include personal identification information prior to transmitting a digital invitation that can be a vehicle access invitation. In response, the queried client device transmits an identifying message that includes the requested personal identification information back to the cloud management module. The cloud management module then transmits a second query requesting the user profile associated with the queried client device. The client device then transmits a responsive message to the cloud management module that includes the requested user profile.

In some embodiments, the vehicle access invitation is transmitted to the client device when the user profile associated with the client device is received by the cloud management module. In so doing, the synchronization module and the cloud management module operate so that the upper limit of the per-seat license is not exceeded. In further embodiments, upon receiving a vehicle access invitation the client device transmits an invitation acceptance to one of the cloud management module, the cloud service directory service, or the synchronization module. The synchronization module, cloud management module, and cloud service directory service operate individually or in concert to synchronize the directory service according to one or more invitation acceptance. Similarly, upon receiving a vehicle access invitation the client device may transmit an invitation declination to one of the cloud management module, the cloud service directory service, or the synchronization module. The synchronization module, cloud management module, and cloud service directory service operate individually or in concert to synchronize the directory service according to one or more invitation declination. When the cloud management module receives either an invitation acceptance or an invitation declination the cloud management module determines whether the invitation acceptance and/or declination exceeds the upper limit of end users. When the cloud management module determines that the upper limit of end users is exceeded, the cloud management module denies access to the cloud service. Alternatively, when the cloud management module determines that the upper limit of end users is not exceeded, the cloud management module authorizes access to the cloud service.

In further embodiments, the second query includes a request for a release associated with the user profile. Additionally, the responsive message includes a release that allows the cloud management module to use, reproduce, and transfer any and all information in a received user profile.

At step 412, a per-seat license is provisioned to the autonomous entity for cloud service utilization, and a unique identifier from the autonomous entity is used to create an initial autonomous user profile for directory services 412. The initial autonomous user profile includes only the unique identifier from the autonomous entity and can be expanded to including further information. The autonomous entity's use of the per-seat license or the associated cloud service may be tracked and used to buildout the autonomous user profile with tasks performed, associated times and locations, etc. In further embodiments, the cloud service or the Licensing Operation Database can simultaneously request a user profile from the autonomous entity and provide a reward. The reward can be a time extension for the provisioned per-seat license or access to additional cloud service features. Thus, a cloud service providing access to a rental electronically accessible vehicle (e-vehicle) may offer luxury add-on features (e.g., private mode that shuts off any internal cameras, XM satellite radio, etc.) or upgrades (e.g., upgrading from compact to sedan, or base model to luxury model) to users that grant access to their user profile or authorize tracking of their cloud service usage (i.e., tracking vehicle location during rental). In this embodiment, one of the cloud service directory services, the directory service synchronization module, or the licensing operational database can record endpoint utilization to buildout a user profile created during the onboarding process. The user profile can thus be built-out with information detailing location, billing details, etc. from a user's cloud service utilization.

In various embodiments, the endpoint or client device includes a user profile associated with the end user of the endpoint. In further embodiments, the endpoint includes personal identification information that may be associated with the endpoint and/or the end user of the endpoint.

MaaS with a single per-seat license 414 is a process including multi-cloud access control 416 to at least a first cloud service 418 and a second cloud service 438. The first cloud service 418 includes a plurality of distinct features including upgrades 420, add-ons 422, data collection 424, and one or more rental e-vehicles 425. The second cloud service provider 438 includes a second plurality of distinct features 432, 434, 436. Moreover, a licensing service 426 and a billing service 430 manage the plurality of distinct features using an operational database service 428. In an illustrative embodiment, the first cloud service 418 is an electronically accessible vehicle rental cloud service including features that can be various electronically accessible rental vehicles comprising a fleet of electronically accessible rental vehicles associated with the electronically accessible vehicle rental cloud service. The features can also include upgrades 420 or corollary add-on 422 features for a particular electronically accessible rental vehicle, such as, a private mode that disengages interior cameras, a dog mode that maintains interior temperatures below a predetermined value (i.e., in one embodiment the predetermined value is 78 F), a remote starter, a movie theater mode (i.e., access to a library of movies viewable in the vehicle), etc.

Billing and payment automation among autonomous entities is based on the passive identification of autonomous entities. The passive identifiers may derive from a plurality of technologies and include radio identifiers, biometrics, and camera recognition. A licensing payment system is comprised of a client, a licensing operator, and a seller. In this embodiment, the client is an autonomous entity, the licensing operator manages the system and method, and the seller is the provider of goods or services.

A per-seat license expiration 440 would terminate access to the associated cloud features or multi-cloud services 442. Thus, each per-seat license includes a time period of validity, the expiration of which invalidates the per-seat license or an end user's access to a per-seat license. In addition, access is terminated upon failure to authenticate payment, license expiration, lack of funds, etc. The synchronization module operates to synchronize the cloud service directory service when one or more per-seat license time period expires. Synchronization between cloud service providers is enabled by a multi-cloud directory service synchronization process 400. The multi-cloud directory service synchronization process 400 allows data collected from one cloud service to be utilized by one or more other cloud services in the multi-cloud.

The system and method for managing an autonomous licensing entity provide access control to a plurality of cloud service features. The cloud service features may contain a collection or bundle of operations associated with a per-seat license or payment scheme including but not limited to automated clearing house (ACH), debit card, credit card, PayPal, cryptocurrency (such as Bitcoin, Litecoin, Ethereum), Blockchain (such as Ripple, Stellar, PayCommerce, Streami or PhunCoin), barter of data or information (such as PhunCoin or GoGet), lead generation, or volume enterprise licensing with payment terms, such as Net 30 or Net 90. A cloud licensing module manages the per-seat license supplied by the autonomous entity, authorizing use of the cloud service and/or updating the directory service with the number and/or identity of active per-seat licenses and autonomous entities.

A billing module registers the costs associated with managing per-seat licensing entities as opposed to regulating usage. The plurality of features includes a variety of capabilities of varying degrees and complexities that may incur a separate charge for each feature or capability that is managed by a billing and payment module. Furthermore, a directory service synchronization module is responsible for synchronizing directory services across cloud services.

A directory service offers the ability to map autonomous entities to particular addresses. A plurality of services provided by directory services includes replication, which is the distribution of directory data across a plurality of geographically distributed servers serving as a coalesced unit of data for control and management. Furthermore, the directory service is optimized for data searching and retrieval of one or more autonomous entity profiles.

An organizational unit is defined as a plurality of autonomous entities of a particular group with a plurality of common denominators. Typically, the hierarchical infrastructure of the organizational units is determined by preconfigured groups in the hierarchical organization of a network of autonomous entities.

The system and method support the X.500 standard protocol for integration and interoperability with an autonomous entity. The X.500 standard protocol is supported by a plurality of services such as Directory Access Protocol (OAP), Directory System Protocol (DSP), Directory Information Shadowing Protocol (DISP), Directory Operational Bindings Management Protocol (DOP), Lightweight Directory Access Protocol (LDAP). Furthermore, implementations using LDAP include Active Directory and OpenLDAP.

A global catalog is a distributed data repository comprising a multi-domain directory forest designated as global catalog servers and distributed through multi-master replication. The Global catalog provides the ability to locate objects from any domain without having to specify a particular domain name. The global catalog server is a domain controller that stores a partial, read-only replica of all other domain directory partitions in the forest. The system has the ability to manage information about objects such as countries, organizations, people (natural intelligence), robots, drones, smart appliances, unmanned vehicles, endpoint vehicles, autonomous virtual desktops (artificial intelligence) or hybrids.

The functionality provided by the directory service enables search and browser information by a name. The name identifies the object allowing an autonomous entity to self-discover other entities in the organizational hierarchy. In addition, the directory services provide centralized authentication, authorization, accounting, and payments.

The plurality of functions provided by the directory service includes autonomous systems for administrative tasks facilitating a centralized management system. The centralized management system provides commands in the form of instructions to an endpoint.

Endpoints integrated into autonomous entities may request services from multiple cloud service providers concurrently.

The system and method synchronizes billing and licensing among a plurality of cloud services and separate or integral secure enclaves. The number of features provided by a cloud service is determined by the availability of resources supporting the plurality of cloud services. Per-seat licenses provisioned to autonomous entities may occur at rates faster than requests originated by human-assisted interaction (e.g., manual mode). For instance, a per-seat license for cloud services may be automatically requested by an autonomous entity in order to set up and use cloud services to satisfy a condition or state required to perform a self-governing function.

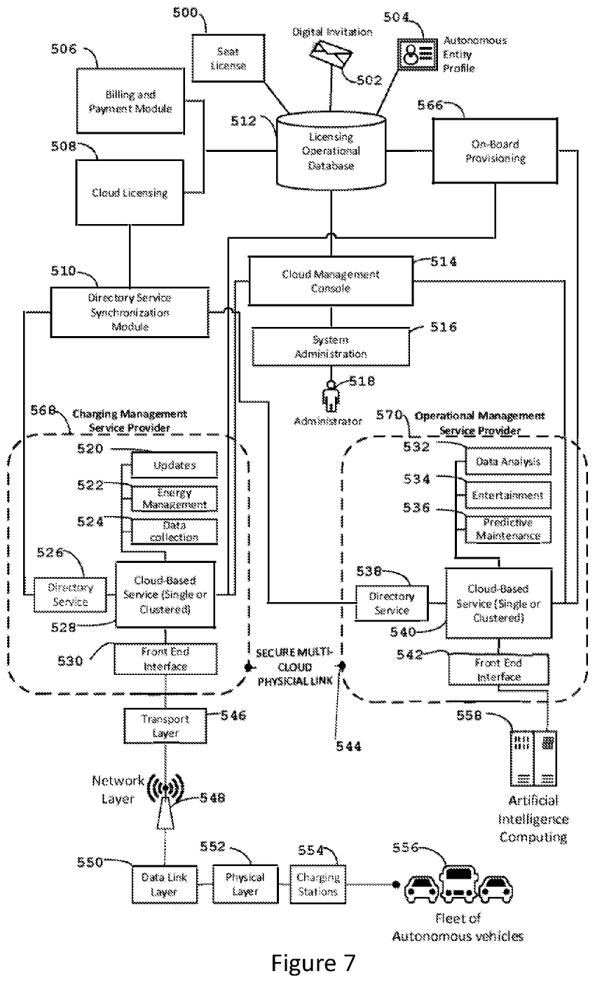

The illustrative embodiment shown in FIG. 7 contains a plurality of autonomous vehicles utilizing a plurality of cloud services through a charging station and a valid per-seat license. The architecture describes a system comprising elements such as a per-seat license 500, a digital invitation 502, and an autonomous entity profile 504 stored in a Licensing operational database 512 or equivalent storage. The system includes a cloud billing module 506, a cloud licensing module 508, and an on-board provisioning system 566 communicatively coupled to the Licensing operational database 512. A Directory Service Synchronization Module 510 is in charge of synchronizing directory services among a plurality of cloud services 568 and 570. A Cloud Management Console 514 is communicatively coupled to a System Administration system 516 used by administrators 518 of the multi-cloud 568, 570. Cloud services 568, 570 include a plurality of distinctive features 520, 522, 524, 532, 534, 536, a directory service 526, 538, a Front End 530, 542, and a Cloud-Based Service (Single or Clustered) 528, 540. A secure multi-cloud physical link is shown 544.

The charging management service provider 568 includes the distinct features of updates 520, energy management 522, and data collection 524. The operational management service provider 570 includes separate distinct features that require Artificial Intelligence computing, such as data analysis 532, entertainment 534, and predictive maintenance 536. The data analysis feature is comprised of tracking systems of vehicles that monitors various vehicle identifiers: license plate colors, vehicle colors, vehicle type, vehicle characteristics, vehicle brand, vehicle model, and driving speed.

A multilayer architecture is shown with a transport layer 546, a network layer 548, a data link layer 550, a physical layer 552, a plurality of charging stations 554, and a fleet of autonomous vehicles 556. The transport layer 546 provides logical communication between application processes running on different hosts within the multilayer architecture and enables end-to-end communication over the multilayer architecture. The network layer 548 is responsible for packet forwarding, i.e. routing through intermediate routers. The data link layer 550 is a protocol-based layer that moves data into and out of the physical link 544 between the charging management service provider 568 and the operational management service provider 570. The physical layer 552 enables bit-level transmission between charging stations 554 and autonomous vehicles 556 by synchronizing communication.

A plurality of autonomous vehicles would need a charging station with MaaS, which is a fundamental characteristic of a machine-to-machine economy with per-seat licenses. An autonomous vehicle is further defined as a self-governing entity capable of performing at least autonomous steering, autonomous navigation, high inference rates, high response time, emergency services, and collision avoidance maneuvers.

The charging stations 554 constitute the interface between an autonomous vehicle, the plurality of cloud services, and an artificial intelligence computer.

MaaS is a real-time service for seamless mobility offered to an autonomous entity using a plurality of cloud services for data aggregation and processing. In another embodiment, a Maas service models include per-seat licenses for subscription business models or over the top services. Furthermore, in one embodiment, a swarm of autonomous vehicles perform transportation services for users with a per-seat license. These transportation services could supplant traditional car ownership models, allowing individual owners to provide rental taxi services on a piece-meal basis; or allowing taxi and car rental agencies to provide driverless (i.e., autonomous vehicle) experiences. In this embodiment, an autonomous vehicle is available to a plurality of users with a per-seat license on demand.

In addition, the embodiment of FIG. 7 includes a per-seat license that allows non-metered usage as opposed to metered usage because the embodiment is considered to be a monolithic environment where a plurality of autonomous entities coexist as a pool of resources available to customers or end users/endpoint devices. An artificial intelligence employs data analysis to keep track of various devices designed to measure time, distance, speed, energy consumption, the flow of energy, etc.

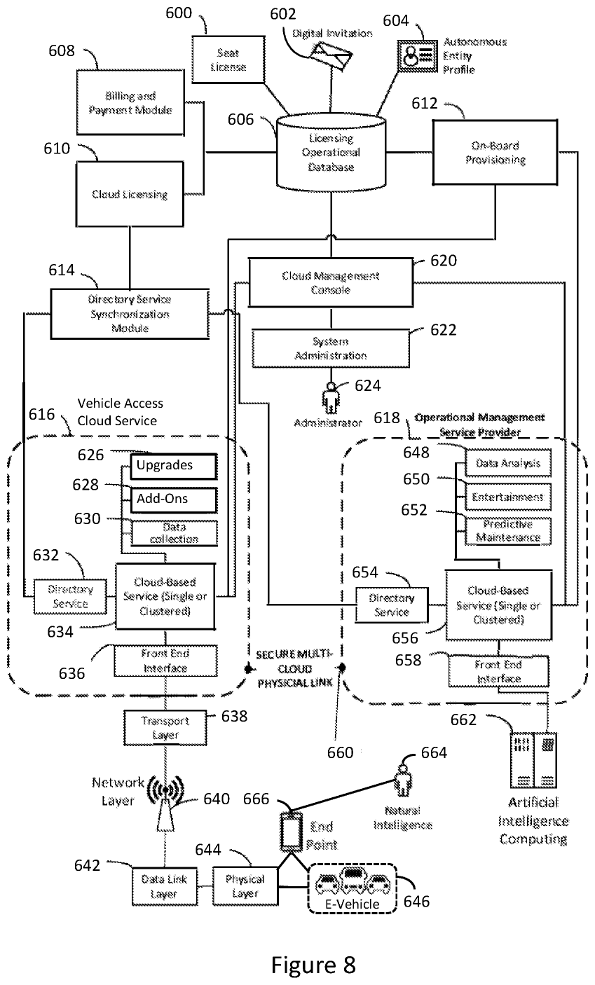

The illustrative embodiment shown in FIG. 8 contains a plurality of electronically accessible vehicles (e-vehicles) utilizing a plurality of cloud services over a wireless network according to a valid per-seat license. The architecture describes a system comprising elements such as a per-seat license 600, a digital invitation 602, and an autonomous entity profile 604 stored in a Licensing operational database 606 or equivalent storage. The system includes a cloud billing module 608, a cloud licensing module 610, and an on-board provisioning system 612 communicatively coupled to the Licensing operational database 606. A Directory Service Synchronization Module 614 is in charge of synchronizing directory services among a plurality of cloud services 616 and 618. A Cloud Management Console 620 is communicatively coupled to a System Administration system 622 used by administrators 624 of the multi-cloud 616 and 618. Cloud services 616 and 618 include a plurality of distinctive features 626, 628, 630, 648, 650, 652, a directory service 632, 654, a Front End 636, 658, and a Cloud-Based Service (Single or Clustered) 634, 656. A secure multi-cloud physical link is shown 660.

The vehicle access cloud service 616 includes the distinct features of upgrades 626, add-ons 628, and data collection 630. The operational management service provider 618 includes separate distinct features that require Artificial Intelligence computing 662, such as data analysis 648, entertainment 650, and predictive maintenance 652. The data analysis feature is comprised of tracking systems of vehicles that monitors various vehicle identifiers: license plate colors, vehicle colors, vehicle type, vehicle characteristics, vehicle brand, vehicle model, and driving speed.

A multilayer architecture is shown with a transport layer 638, a network layer 640, a data link layer 642, a physical layer 644, and a fleet of electronically accessible vehicles (e-vehicles) 646. The transport layer 638 provides logical communication between application processes running on different hosts within the multilayer architecture and enables end-to-end communication over the multilayer architecture. The network layer 640 is responsible for packet forwarding, i.e. routing through intermediate routers. The data link layer 642 is a protocol-based layer that moves data into and out of the physical link 660 between the charging management service provider 616 and the operational management service provider 618. The physical layer 644 enables bit-level transmission between endpoints 666 operated by a natural intelligence 664 and e-vehicles 646 by synchronizing communication, and bit-level transmission among e-vehicles 646 by synchronizing communication.

A plurality of e-vehicles may require a charging station with MaaS, which is a fundamental characteristic of a machine-to-machine economy with per-seat licenses. This MaaS facilitated charging station may also support charging for e-vehicles operated by a natural intelligence in a natural-to-machine economy with per-seat licenses.

MaaS is a real-time service for seamless mobility offered to endpoints using a plurality of cloud services for data aggregation and processing. In another embodiment, a Maas service models include per-seat licenses for subscription business models or over the top services. Furthermore, a fleet of e-vehicles would be available for rental by users with a per-seat license, such as individuals requesting metered usage or corporate accounts requesting unmetered usage for constant and widespread availability. In this embodiment, an autonomous vehicle is available to a plurality of users with a per-seat license, such that only a single user utilizes a single e-vehicle at a given time. This system provides an alternative to existing car rental models that require administrative human interaction to facilitate a rental contract. Additionally, this system is not limited to providing and managing per-seat licenses for e-vehicles, but may extend to any electronically accessible machine, such as a robot, a drone, etc.

As discussed above, the embodiment of FIG. 8 includes a per-seat license that allows non-metered usage as well as measured usage, though the embodiment is considered to be a monolithic environment where a plurality of autonomous entities coexist in a pool of resources. An artificial intelligence employs data analysis to keep track of various devices designed to measure time, distance, speed, energy consumption, the flow of energy, et al.

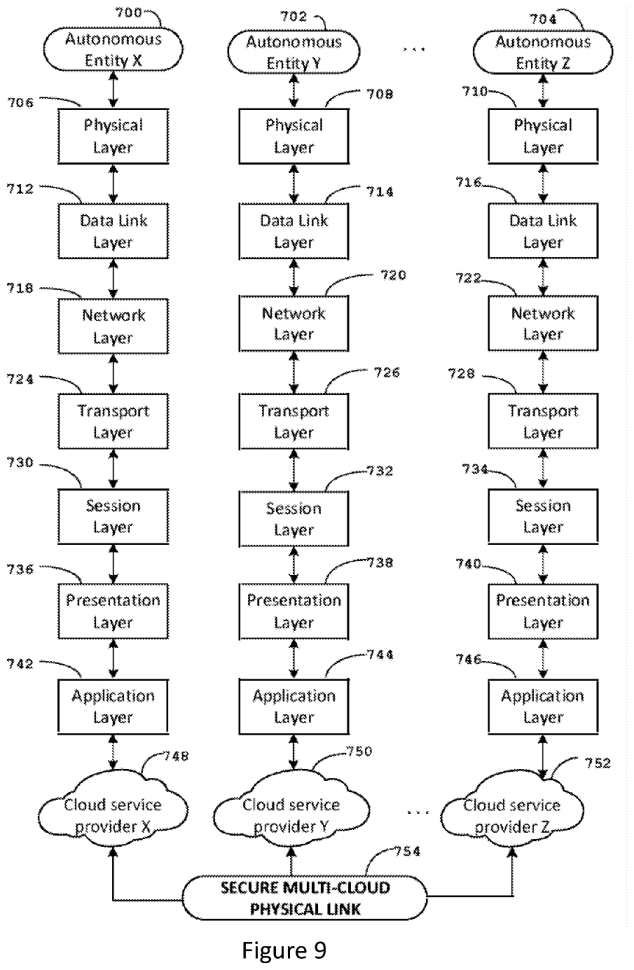

FIG. 9 shows a flowchart of a layer model using a multi-cloud architecture. In FIG. 9, a plurality of autonomous entities comprising autonomous entity X 700, autonomous entity Y 702, autonomous entity Z 704 are communicatively coupled using a secure multi-cloud physical link 754. The multilayer method includes a physical layer 706, 708, 710, a data link layer 712, 714, 716, a network layer 718, 720, 722, a transport layer 724, 726, 728, a session layer 730, 732, 734, a presentation layer 736, 738, 7 40, an application layer 742, 744, 746, a cloud service provider layer 748, 750, 752, and a secure multi-cloud physical link 754.

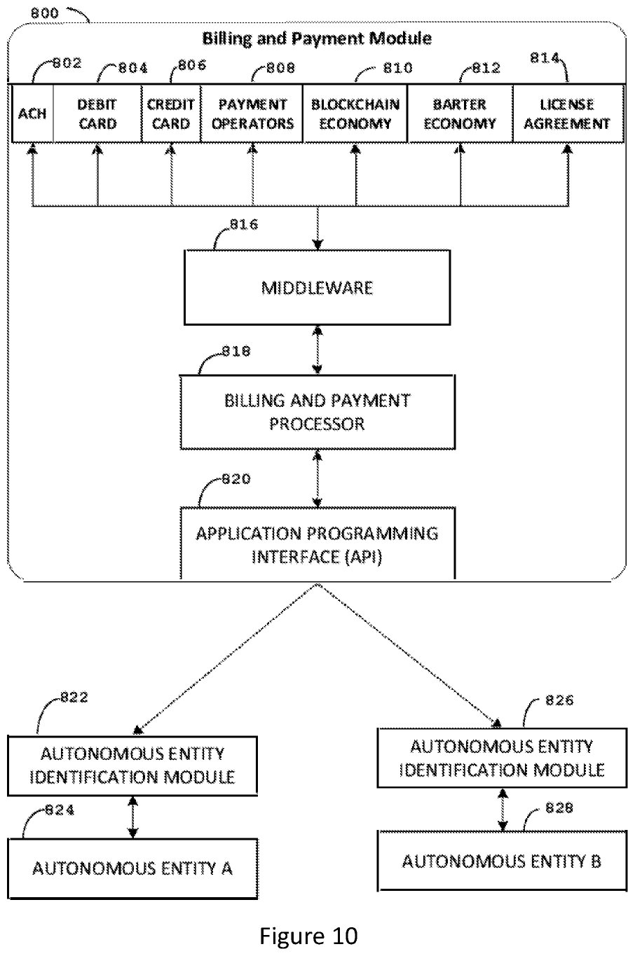

FIG. 10 shows an automated passive payment architecture for autonomous entities. The billing and payment module 800 is comprised of a plurality of payment schemes such as automated clearing house (ACH) 802, debit card 804, credit card 806, payment operators 808, cryptocurrency and blockchain 810, lead generation (not shown), barter for information or data exchange or advertisement or search results 812, and license agreement 814. A middleware 816 provides an external interface to the plurality of payment schemes and a billing and payment processor 812. In addition, the billing and payment module 800 include a billing and payment application programming interface (API) for licensing payment using identification modules 822, 826 of autonomous entities A 824 and autonomous entities B 828. The billing and payment processor 812 perform the authorization of billing and payment transactions.

The physical layer deals with the aspects of transmitting data using the best available WAN connection to transmit TCP/IP data. The data link layer deals with the transmission of packets over the physical link and error correction. The network layer establishes paths between autonomous entities for routing and switching. The transport layer transfers data between autonomous entities using flow control. The session layer relates and manages the per-seat licenses of autonomous entities. The presentation layer is responsible for presenting raw data from and to autonomous entities. The application layer deals with incompatibilities among autonomous entities by means of a custom interface. The cloud service provider layer includes a plurality of cloud service providers communicatively coupled with a multi-cloud physical link.

It is to be understood that the detailed description of illustrative embodiments are provided for illustrative purposes. Thus, the degree of software modularity for the transactional system and method presented above may evolve to benefit from the improved performance and lower cost of the future hardware components that meet the system and method requirements presented. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A licensing system for managing a vehicle cloud service comprising:
a per-seat license associated with the vehicle cloud service that includes an upper limit of end users that can access the vehicle cloud service and an end date for the per-seat license, wherein the vehicle cloud service is communicatively coupled to a network and an electronically accessible vehicle;
a directory service communicatively coupled to a server via a network, wherein the directory service manages the per-seat license associated with the vehicle cloud service;
a client device communicatively coupled to the network, wherein the client device includes a user profile;
a cloud management module communicatively coupled to the directory service and the vehicle cloud service;
a query originating from the cloud management module, wherein the query requests identification of the client device;
an identifying message originating from the client device, wherein the identifying message includes the user profile;
a vehicle access invitation originating from the cloud management module, wherein the vehicle access invitation authorizes the per-seat license associated with the vehicle cloud service, and wherein the vehicle access invitation is transmitted to the client device when the user profile associated with the client device is received by the cloud management module; and
a synchronization module that synchronizes the directory service according to the vehicle access invitation so that the upper limit of the per-seat license is not exceeded.

2. The licensing system for managing a vehicle cloud service of claim 1 further including:
an invitation acceptance originating from the client device; and
wherein the synchronization module synchronizes the directory service according to the invitation acceptance.

3. The licensing system for managing a vehicle cloud service of claim 1 further including:
an invitation declination originating from the client device; and
wherein the synchronization module synchronizes the directory service according to the invitation declination.

4. The licensing system for managing a vehicle cloud service of claim 1 wherein the vehicle access invitation includes a time period, and wherein the invitation is invalid upon expiration of the time period.

5. The licensing system for managing a vehicle cloud service of claim 4 wherein the synchronization module synchronizes the directory service according to the expiration of the time period.

6. The licensing system for managing a vehicle cloud service of claim 2 wherein the cloud management module determines that the invitation acceptance exceeds the upper limit of end users and denies access to the cloud service.

7. The licensing system for managing a vehicle cloud service of claim 2 wherein the cloud management module determines that the invitation acceptance does not exceed the upper limit of end users and authorizes access to the cloud service.

8. A licensing system for managing a vehicle cloud service comprising:
a per-seat license associated with the vehicle cloud service that includes an upper limit of end users that can access the vehicle cloud service and an end date for the per-seat license, wherein the vehicle cloud service is communicatively coupled to a network and an electronically accessible vehicle;
a means for managing the per-seat license associated with the vehicle cloud service;
a client device communicatively coupled to the network, wherein the client device includes a user profile;
a cloud management module communicatively coupled to the directory service and the vehicle cloud service;
a query from the cloud management module, wherein the second query requests the user profile associated with the client device;
a responsive message originating from the client device, wherein the responsive message includes the user profile;
a vehicle access invitation originating from the cloud management module, wherein the vehicle access invitation authorizes the per-seat license associated with the vehicle cloud service, and wherein the vehicle access invitation is transmitted to the client device when the user profile associated with the client device is received by the cloud management module; and
a means for synchronizing the directory service according to the vehicle access invitation so that the upper limit of the per-seat license is not exceeded.

9. The licensing system for managing a vehicle cloud service of claim 8 further including:
an invitation acceptance originating from the client device; and
wherein the synchronization module synchronizes the directory service according to the invitation acceptance.

10. The licensing system for managing a vehicle cloud service of claim 8 further including:
an invitation declination originating from the client device; and
wherein the synchronization module synchronizes the directory service according to the invitation declination.

11. The licensing system for managing a vehicle cloud service of claim 8 wherein the vehicle access invitation includes a time period, and wherein the invitation is invalid upon expiration of the time period.

12. The licensing system for managing a vehicle cloud service of claim 11 wherein the synchronization module synchronizes the directory service according to the expiration of the time period.

13. The licensing system for managing a vehicle cloud service of claim 9 wherein the cloud management module determines that the invitation acceptance exceeds the upper limit of end users and denies access to the cloud service.

14. The licensing system for managing a vehicle cloud service of claim 9 wherein the cloud management module determines that the invitation acceptance does not exceed the upper limit of end users and authorizes access to the cloud service.

15. A method for managing a vehicle cloud service comprising:
querying, by a cloud management module, a client device to request identification of the client device, wherein the request is transmitted via a network coupled to the cloud management module and the client device;
querying, by the cloud management module, the client device to request a user profile associated with the client device;
transmitting, by the client device, a responsive message, wherein the responsive message includes the user profile associated with the client device;
receiving, by the cloud management module, the responsive message from the client device;
transmitting, by the cloud management module, a vehicle access invitation when the user profile associated with the client device is received by the cloud management module, wherein the vehicle access invitation authorizes a per-seat license associated with the vehicle cloud service, wherein the per-seat license includes an upper limit; and
synchronizing, by a synchronization module, a directory service according to the vehicle access invitation, wherein the directory service manages the per-seat license associated with the vehicle cloud service so that the upper limit of the per-seat license is not exceeded, wherein the directory service is communicatively coupled to the network.

16. The licensing method for managing a vehicle cloud service of claim 15 further including:
transmitting, by the client device, an invitation acceptance; and
synchronizing, by the synchronization module, the directory service according to the invitation acceptance.

17. The licensing method for managing a vehicle cloud service of claim 15 further including:
transmitting, by the client device, an invitation declination; and
synchronizing, by the synchronization module, the directory service according to the invitation declination.

18. The licensing method for managing a vehicle cloud service of claim 15 wherein the vehicle access invitation includes a time period, and wherein the invitation is invalid upon expiration of the time period.

19. The licensing method for managing a vehicle cloud service of claim 16 further comprising:
determining that the invitation acceptance exceeds the upper limit of end users; and
denying access to the cloud service.

20. The licensing method for managing a vehicle cloud service of claim 16 further comprising:
determining that the invitation acceptance does not exceed the upper limit of end users; and
authorizing access to the cloud service.
